(19) United States
(12) Patent Application Publication
(10) Pub. No.: US 2018/0295836 A1
(43) Pub. Date: Oct. 18, 2018

(54) NANOCOMPOSITE COMPOSITIONS COMPRISING MULTI-VALENT METAL MATERIAL AND IMMOBILIZED QUAT MATERIAL, METHODS OF MAKING THE COMPOSITIONS AND METHODS OF USING THE COMPOSITIONS

(71) Applicant: UNIVERSITY OF CENTRAL FLORIDA RESEARCH FOUNDATION, INC., Orlando, FL (US)

(72) Inventors: Swadeshmukul Santra, Orlando, FL (US); Ali Ozcan, Orlando, FL (US); Mikaeel Young, Orlando, FL (US)

(73) Assignee: UNIVERSITY OF CENTRAL FLORIDA RESEARCH FOUNDATION, INC., Orlando, FL (US)

(21) Appl. No.: 15/767,421

(22) PCT Filed: Oct. 13, 2016
(86) PCT No.: PCT/US2016/056922

§ 371 Date: Apr. 11, 2018

Related U.S. Application Data
(60) Provisional application No. 62/240,914, filed on Oct. 13, 2015.

(51) Int. Cl. A01N 25/26; A01N 59/20; A01N 33/12

(52) U.S. Cl. CPC A01N 25/26; A01N 59/06; A01N 33/12; A01N 59/20

(57) ABSTRACT

A nanoparticle for use within a composition for treating tomatoes as well as other agricultural products comprises: (1) a first shell layer comprising a leachant permeable base material in addition to a multi-valent metal (i.e., typically copper) material; and (2) a second shell layer comprising a Quat material. Due to the multi-valent metal material and the Quat, the nanoparticle and the composition provide superior performance when treating tomatoes.

### CROSS-REFERENCE TO RELATED APPLICATION

This application is the U.S. National Stage Application under 35 U.S.C. 371 of PCT Application No. PCT/US2016/056922, filed Oct. 13, 2016, that relates and claims priority to U.S. Provisional Patent Application Ser. No. 62/240,914, filed Oct. 13, 2015, and titled “Multimodal/multifunctional Locally Systemic Pesticides,” the entire contents of each of which are hereby incorporated by reference.

### BACKGROUND

The globalization of business, travel and communication brings increased attention to worldwide exchanges between communities and countries, including the potential globalization of the bacterial and pathogenic ecosystem. Bactericides and fungicides have been developed to control diseases in man, animals, and plants, and must evolve to remain effective as more and more antibiotic, pesticide, and insecticide resistant bacteria and fungi appear around the globe.

Bacterial resistance to antimicrobial agents has also emerged, throughout the world, as one of the major threats to both man and the agrarian lifestyle. Resistance to antibacterial and antifungal agents has emerged as an agricultural issue that requires attention and improvements in the treatment materials are in use today.

For example, focusing on plants, there are over 300,000 diseases that afflict plants worldwide, resulting in billions of dollars of annual crop losses. The antibacterial/antifungal formulations in existence today could be improved and made more effective.

### SUMMARY

As an exemplary consideration, owing to the absence of suitable copper material alternatives, in order to maintain productivity of tomato harvests, tomato growers have been aggressively using commercial copper hydroxide bactericides at very high application rates (up to 500 ppm of metallic copper rate and up to 2-3 times a week during a peak time of the season). With such aggressive use of copper hydroxide bactericides for the past decade or so, some fields might have already reached a very high level of copper material accumulation in soil. It is noted that copper material toxicity in the environment is a serious concern as the United States Environmental Protection Agency (EPA) contaminant remediation level in soil for copper materials is 1.3 ppm copper equivalent.

It is therefore anticipated, and in particular, that some tomato fields may no longer be approved for application of copper material bactericides at the current level in the near future. This situation will likely cause a significant productivity loss for tomato growers, negatively impacting the U.S. economy. Thus, for instance, both treatment of copper material resistant strains and reduction of copper material contaminant, in the environment urgently demand innovation that will seminally change performance of traditional copper material based agricultural bactericides.

Within the context of the foregoing, and according to an embodiment, the present invention relates to a novel copper-based local-systemic particle (LSP) material, which has been specifically designed to be effective against copper-material-resistant bacteria (such as X. perforans), at significantly lower copper material concentrations than current use of otherwise traditional and conventional copper material pesticides.

The embodiments are predicated upon a novel concept of developing copper-based LSP material compositions with particular classes of materials which have not heretofore been considered, where the particular classes of materials provide for: (1) innovative technical approaches that derive from fundamental science; and (2) enhanced agricultural crop protection that leads to enhanced food security. An optimized formulation of LSP material composition (that includes, for instance, active materials and inert filler materials), in accordance with the embodiments, will contain only chemical and material components which are EPA approved for “Food Use.” As such, LSP technology, in accordance with the embodiments, revolutionizes the agriculture industry by providing effective material compositions that allow farmers to combat “difficult to manage” bacterial diseases, such as, tomato bacterial spot.

According to an embodiment, the advances in nanotechnology have been used to design and develop novel LSP material compositions for improving efficacy of copper-based bactericides against copper-resistant plant pathogens and reduce impact of copper material accumulation in the environment. To achieve this desirable result, the embodiments disclosed herein challenge the boundaries of contemporary nanotechnology so as to enable measurement of LSP material distribution and composition in plant tissue at a molecular and nanoscale level.

Specific objectives of the embodiments disclosed herein include: (1) development of industrially viable bi-modal LSP material formulations containing multi-valent copper material and immobilized Quat (i.e., quaternary ammonium) material nanoparticles; (2) evaluation of efficacy of LSP material relative to standard copper-material pesticides against copper-material resistant bacteria (e.g. X. perforans in vitro), and tomato-bacterial spot disease in greenhouse and field conditions.

The embodiments in one aspect relate to copper material compositions including a multi-valent copper material and an immobilized Quat material nanocomposite particulate, methods of making the composition, methods of using the composition, and the like.

In an embodiment, a composition, among others, includes at least one nanoparticle, the at least one nanoparticle comprising: (1) a first shell layer, the first shell layer comprising: (a) a leachant permeable base material; and (b) at least two different valence states of a metal material distributed and doped with respect to the leachant permeable base material, to provide a first multi-valent metal material doped shell layer. The at least one nanoparticle also includes a second shell layer encapsulating the first multi-valent metal material doped shell layer and comprising an immobilized Quat material.

In an embodiment, a method, among others, includes treating a plant with a composition, the composition comprising at least one nanoparticle, the at least one nanoparticle comprising: (1) a first shell layer comprising: (a) a leachant permeable base material; and at least two different valence states of a metal material distributed and doped with respect to the leachant permeable base material, to provide a first multi-valent metal material doped shell layer. This particular method also includes forming a second shell layer encapsulating the first multi-valent metal material doped shell layer and comprising an immobilized Quat material.

In an embodiment, another method, among others, includes forming a first shell layer that comprises a leachant permeable base material that includes at least two different valence states of a metal material distributed with respect to the leachant permeable base material to provide a first multi-valent metal material doped shell layer. This particular method also includes forming upon the first multi-valent metal material doped shell layer a second shell layer encapsulating the first multi-valent metal material doped shell layer and comprising an immobilized Quat material.

Other compositions, methods, features, and advantages of the embodiments will be, or become, apparent to one with skill in the art upon examination of the following drawings and detailed description.

The embodiments contemplate that compositions, methods, features and advantages may include compositions that may be defined with a limited number of limitations, or negative limitations, as presented and described above. It is intended that all such additional structures, compositions, methods, features, and advantages be included within this description, be within the scope of the present disclosure, and be protected by the accompanying claims.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates a schematic representation of a bi-modal locally systemic particle (LSP) material (left image) and, as depicted, also includes LSP material uptake through stomata and their potential locally-systemic distribution in plant tissue (right image).

FIG. 2 illustrates a representative example of field-emission scanning electron microscopy (FE-SEM) image of silica nanoparticle (SiNPs) comparable with those of a Cu-loaded silica shell particles and Fixed-Quat loaded silica particles mixed with copper, respectively.

FIG. 3 illustrates a representative example of high-resolution transmission electron microscopy (HR-TEM) image of Cu loaded silica matrix with scattered dark contrast confirming presence of electron-rich material. Cu crystallites can be seen with sizes 3-7 nm. Lattice spacings measured from HR-TEM are about 1.87 A° and about 2.44 A° which corresponds to CuO and Cu₂O respectively. This material constitutes a first shell part of the LSP particle.

FIG. 4 illustrates a representative example of phytotoxicity (plant tissue injury) results obtained from formulations sprayed on ornamental Vinca sp. (used as model plant species which is highly susceptible to phytotoxicity; as considered by the industry) in greenhouse conditions. Approximately 10 mL of the formulation was sprayed on plants at 7:30 am on the test day. Digital image on left showing leaves treated with formulations at 900 ppm of metallic Cu. All treatments were found to be non-phytotoxic up to 500 ppm (see the Table on right). Only moderate phytotoxicity was observed for the multi-valent Cu after 48 hrs. (−) represents “non-phytotoxic” while (+) and (++) represents “moderately” and “severely phytotoxic.”

FIG. 5 illustrates a representative example of a Fourier-Transform Infrared Spectroscopy (FIR) (left) and Raman (right) spectra of five solutions including Kocide® 3000 control (red) and preliminary test solutions of Silica-Cu with Mixed valence Cu (green), Core-shell Cu (blue), and Quat (pink). Raman spectra, in particular, exhibit sharp peaks that can be used for imaging and identification of the Lisps in plant tissues.

FIGS. 6A-6B illustrate representative examples of dynamic light scattering (DSP) of LSP formulations relative to that of a silica core. As depicted, the highly monodisperse (polydispersity index (PDI)<0.1) silica cores with 3 different sizes were synthesized, and Cu loading and silica shell formation, respectively, were also optimized to have highest Cu content/NP while minimizing particle aggregation. As depicted in FIG. 6B, a change in peak position indicated the formation of shell. LSP 1 having a 45 nm silica nanoparticle (SiNP) core was used as the core. Upon Cu loaded silica shell coating, the peak position was shifted to 60 nm.

### DETAILED DESCRIPTION

Before the embodiments that comprise the present disclosure are described in greater detail, it is to be understood that this disclosure is not limited to particular embodiments described, and as such may of course vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described, as above and below.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features that may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, polymer chemistry, biology, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmospheres. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Definitions (which are not Necessarily Limited to the Present Disclosure)

The term “antimicrobial characteristic” refers to the ability to kill and/or inhibit the growth of microorganisms. A substance having an antimicrobial characteristic may be harmful to microorganisms (e.g., bacteria, fungi, protozoans, algae, and the like). A substance having an antimicrobial characteristic can kill the microorganism and/or prevent or substantially prevent or inhibit the growth or reproduction of the microorganism.

The term “antibacterial characteristic” refers to the ability to kill and/or inhibit the growth of bacteria. A substance having an antibacterial characteristic may be harmful to bacteria. A substance having an antibacterial characteristic can kill the bacteria and/or prevent or substantially prevent or inhibit the replication or reproduction of the bacteria.

“Gel matrix” or “Nanogel matrix” refers to amorphous gel like substance that is formed by the interconnection of multi-valent copper material to one another. In an embodiment, the amorphous gel matrix has no ordered (e.g., defined) structure. In an embodiment, the multi-valent copper material nanoparticles are interconnected covalently (e.g., through —Si—O—Si— bonds), physically associated via Van der Waal forces, and/or through ionic interactions.

“Uniform plant surface coverage” refers to a uniform and complete (e.g., about 100%) wet surface due to spray application of embodiments of the present disclosure. In other words, spray application causes embodiments of the present disclosure to spread throughout the plant surface.

“Substantial uniform plant surface coverage” refers to about 70% or more, about 80% or more, about 90% or more, or more uniform plant surface coverage.

“Substantially covering” refers to covering about 70% or more, about 80% or more, about 90% or more, or more, of the leaves and branches of a plant.

“Plant” refers to trees, plants, shrubs, flowers, and the like as well as portions of the plant such as twigs, leaves, stems, branches, fruit, flowers, and the like. In a particular embodiment, the term plant includes a fruit tree such as a citrus tree (e.g., orange tree, lemon tree, lime tree, and the like).

As used herein, “treat,” “treatment,” “treating,” and the like refer to acting upon a disease or condition with a composition of the present disclosure to affect the disease or condition by improving or altering it. In addition, “treatment” includes completely or partially preventing (e.g., about 70% or more, about 80% or more, about 90% or more, about 95% or more, or about 99% or more) a plant form acquiring a disease or condition. The phrase “prevent” can be used instead of treatment for this meaning. “Treatment,” as used herein, covers one or more treatments of a disease in a plant, and includes: (a) reducing the risk of occurrence of the disease in a plant predisposed to the disease but not yet diagnosed as infected with the disease (b) impeding the development of the disease, and/or (c) relieving the disease, e.g., causing regression of the disease and/or relieving one or more disease symptoms.

As used herein, the terms “application,” “apply,” and the like, within the context of the terms “treat,” “treatment,” “treating” or the like, refers to the placement or introduction of a composition of the disclosure onto or into a “plant” in accordance with the disclosure so that the composition in accordance with the disclosure may “treat” a plant disease in accordance with the disclosure. The Detailed Description of the Embodiments specifically teach: (1) a foliar “application” through use of a spray method or a drench method with respect to a “plant” leaf; or (2) a root “application” through the spray method or the drench method with respect to a growth medium. Within this disclosure an “application” is intended to be broadly interpreted to include any extrinsic method or activity that provides for, or results in, introduction of a composition in accordance with the disclosure onto or into a “plant” in accordance with the disclosure. Such methods or activities may include, but are not necessarily limited to spray methods, drench methods and hypodermic or other injection methods.

The term “local systemic particle” refers, in accordance with the disclosure, to a nanoparticle that moves into treated leaves, and is redistributed locally within the treated portion of the plant. As one skilled in the art will understand, “locally-systemic particle” (LSP) significantly differs from “truly-systemic particle” and “upwardly-systemic particle”. For instance, “truly-systemic particle” refers to a nanoparticle that moves freely throughout the plant, upon treatment with the nanoparticle, and the “upwardly-systemic particle” refers to a nanoparticle that moves only upward in the plant through xylem tissue, respectively.

The terms “bacteria” or “bacterium” include, but are not limited to, Gram positive and Gram negative bacteria. Bacteria can include, but are not limited to, Abiotrophia, Achromobacter, Acidaminococcus, Acidovorax, Acinetobacter, Actinobacillus, Actinobaculum, Actinomadura, Actinomyces, Aerococcus, Aeromonas, Afipia, Agrobacterium, Alcaligenes, Alloiococcus, Alteromonas, Amycolata, Amycolatopsis, Anaerobospirillum, Anabaena affinis and other cyanobacteria (including the Anabaena, Anabaenopsis, Aphanizomenon, Camesiphon, Cylindrospermopsis, Gloeobacter Hapalosiphon, Lyngbya, Microcystis, Nodularia, Nostoc, Phormidium, Planktothrix, Pseudoanabaena, Schizothrix, Spirulina, Trichodesmium, and Umezakia genera) Anaerorhabdus, Arachnia, Arcanobacterium, Arcobacter, Arthrobacter, Atopobium, Aureobacterium, Bacteroides, Balneatrix, Bartonella, Bergeyella, Bifidobacterium, Bilophila Branhamella, Borrelia, Bordetella, Brachyspira, Brevibacillus, Brevibacterium, Brevundimonas, Brucella, Burkholderia, Buttiauxella, Butyrivibrio, Calymmatobacterium, Campylobacter, Capnocytophaga, Cardiobacterium, Catonella, Cedecea, Cellulomonas, Centipeda, Chlamydia, Chlamydophila, Chromobacterium, Chyseobacterium, Chryseomonas, Citrobacter, Clostridium, Collinsella, Comamonas, Corynebacterium, Coxiella, Cryptobacterium, Delftia, Dermabacter, Dermatophilus, Desulfomonas, Desulfovibrio, Dialister, Dichelobacter, Dolosicoccus, Dolosigranulum, Edwardsiella, Eggerthella, Ehrlichia, Eikenella, Empedobacter, Enterobacter, Enterococcus, Erwinia, Erysipelothrix, Escherichia, Eubacterium, Ewingella, Exiguobacterium, Facklamia, Filifactor, Flavimonas, Flavobacterium, Francisella, Fusobacterium, Gardnerella, Gemella, Globicatella, Gordona, Haemophilus, Hafnia, Helicobacter, Helococcus, Holdemania Ignavigranum, Johnsonella, Kingella, Klebsiella, Kocuria, Koserella, Kurthia, Kytococcus, Lactobacillus, Lactococcus, Lautropia, Leclercia, Legionella, Leminorella, Leptospira, Leptotrichia, Leuconostoc, Listeria, Listonella, Megasphaera, Methylobacterium, Microbacterium, Micrococcus, Mitsuokella, Mobiluncus, Moellerella, Moraxella, Morganella, Mycobacterium, Mycoplasma, Myroides, Neisseria, Nocardia, Nocardiopsis, Ochrobactrum, Oeskovia, Oligella, Orientia, Paenibacillus, Pantoea, Parachlamydia, Pasteurella, Pediococcus, Peptococcus, Peptostreptococcus, Photobacterium, Photorhabdus, Phytoplasma, Plesiomonas, Porphyrimonas, Prevotella, Propionibacterium, Proteus, Providencia, Pseudomonas, Pseudonocardia, Pseudoramibacter, Psychrobacter, Rahnella, Ralstonia, Rhodococcus, Rickettsia Rochalimaea Roseomonas, Rothia, Ruminococcus, Salmonella, Selenomonas, Serpulina, Serratia, Shewenella, Shigella, Simkania, Slackia, Sphingobacterium, Sphingomonas, Spirillum, Spiroplasma, Staphylococcus, Stenotrophomonas, Stomatococcus, Streptobacillus, Streptococcus, Streptomyces, Succinivibrio, Sutterella, Suttonella, Tatumella, Tissierella, Trabulsiella, Treponema, Tropheryma, Tsakamurella, Turicella, Ureaplasma, Vagococcus, Veillonella, Vibrio, Weeksella, Wolinella, Xanthomonas, Xenorhabdus, Yersinia, and Yokenella. Other examples of bacterium include Mycobacterium tuberculosis, M. bovis, M. typhimurium, M. bovis strain BCG, BCG substrains, M. avium, M. intracellulare, M. africanum, M. kansasii, M. marinum, M. ulcerans, M. avium subspecies paratuberculosis, Staphylococcus aureus, Staphylococcus epidermidis, Staphylococcus equi, Streptococcus pyogenes, Streptococcus agalactiae, Listeria monocytogenes, Listeria ivanovii, Bacillus anthracis, B. subtilis, Nocardia asteroides, and other Nocardia species, Streptococcus viridans group, Peptococcus species, Peptostreptococcus species, Actinomyces israelii and other Actinomyces species, and Propionibacterium acnes, Clostridium tetani, Clostridium botulinum, other Clostridium species, Pseudomonas aeruginosa, other Pseudomonas species, Campylobacter species, Vibrio cholera, Ehrlichia species, Actinobacillus pleuropneumonias, Pasteurella haemolytica, Pasteurella multocida, other Pasteurella species, Legionella pneumophila, other Legionella species, Salmonella typhi, other Salmonella species, Shigella species Brucella abortus, other Brucella species, Chlamydi trachomatis, Chlamydia psittaci, Coxiella burnetti, Escherichia coli, Neiserria meningitidis, Neiserria gonorrhea, Haemophilus influenzae, Haemophilus ducreyi, other Hemophilus species, Yersinia pestis, Yersinia enterolitica, other Yersinia species, Escherichia coli, E. hirae and other Escherichia species, as well as other Enterobacteria, Brucella abortus and other Brucella species, Burkholderia cepacia, Burkholderia pseudomallei, Francisella tularensis, Bacteroides fragilis, Fudobascterium nucleatum, Provetella species, and Cowdria ruminantium, or any strain or variant thereof. The Gram-positive bacteria may include, but is not limited to, Gram positive Cocci (e.g., Streptococcus, Staphylococcus, and Enterococcus). The Gram-negative bacteria may include, but is not limited to, Gram negative rods (e.g., Bacteroidaceae, Enterobacteriaceae, Vibrionaceae, Pasteurellae and Pseudomonadaceae). In an embodiment, the bacteria can include Mycoplasma pneumoniae.

The term “protozoan” as used herein includes, without limitations flagellates (e.g., Giardia lamblia), amoeboids (e.g., Entamoeba histolitica), and sporozoans (e.g., Plasmodium knowlesi) as well as ciliates (e.g., B. coli). Protozoan can include, but it is not limited to, Entamoeba coli, Entamoeabe histolitica, Iodoamoeba buetschlii, Chilomastix meslini, Trichomonas vaginalis, Pentatrichomonas homini, Plasmodium vivax, Leishmania braziliensis, Trypanosoma cruzi, Trypanosoma brucei, and Myxoporidia.

The term “algae” as used herein includes, without limitations microalgae and filamentous algae such as Anacystis nidulans, Scenedesmus sp., Chlamydomonas sp., Clorella sp., Dunaliella sp., Euglena so., Prymnesium sp., Porphyridium sp., Synechoccus sp., Botryococcus braunii, Crypthecodinium cohnii, Cylindrotheca sp., Microcystis sp., Isochrysis sp., Monallanthus salina, M. minutum, Nannochloris sp., Nannochloropsis sp., Neochloris oleoubundans, Nitzschia sp., Phaeodactylum tricornutum, Schizochprium sp., Senedesmus obliquus, and Tetraselmis sueica as well as algae belonging to any of Spirogyra, Cladophora, Vaucheria, Pithophora and Enteromorpha genera.

The term “fungi” as used herein includes, without limitations, a plurality of organisms such as molds, mildews and rusts and include species in the Penicillium, Aspergillus, Acremonium, Cladosporium, Fusarium, Mucor, Nerospora, Rhizopus, Tricophyton, Botryotinia, Phytophthora, Ophiostoma, Magnaporthe, Stachybotrys and Uredinalis genera.

### Discussion:

In accordance with the purpose(s) of the present disclosure, as embodied and broadly described herein, embodiments of the present disclosure, in one aspect, relate to compositions including LSP material compositions comprising particular copper-material components and an immobilized Quat component, methods of making the composition, methods of using the composition, and the like.

In an embodiment, the composition can be used as an antimicrobial agent to kill and/or inhibit the formation of microorganisms on a surface such as a tree, plant, and the like. An advantage of the present disclosure is that the composition is water soluble, film-forming, has antimicrobial properties, and is non-phytotoxic. In particular, the composition is antimicrobial towards E. coli and X. alfalfae and is nonphytotoxic to ornamental vinca sp. In one embodiment, the composition has antimicrobial activity towards microbial organisms, such as, but are not limited to, Xanthomonas citri subsp. citri, a causal agent of Citrus Canker; Elsinoe fawcetti, a causal agent of citrus scab; and Diaporthe citri, a causal agent of melanose, as well as X. perforans.

In another embodiment, the composition can be used as a locally-systemic antimicrobial agent to kill and/or inhibit the formation and/or growth of microorganisms within a plant, tree, and the like. In such embodiment, the locally-systemic particles are able to enter the plant via the roots/vascular system and/or via the leaf stroma. In such an example, the size of the locally systemic particles are similar to the size of phloem proteins (e.g., approximately 10 nm or less) and can thus be transported to phloem regions of plant species for potential treatment of surface, sub-surface and locally-systematic microbial species.

In addition, embodiments of the present disclosure provide for a composition that can be used for multiple purposes. Embodiments of the present disclosure are advantageous in that they can substantially prevent and/or treat or substantially treat a disease or condition in a plant and act as an antibacterial and/or antifungal, while being non-phytotoxic.

In an embodiment, the composition may have an antimicrobial characteristic. The phrase “antimicrobial characteristic” can have the following meaning: kills about 70% or more, about 80% or more, about 90% or more, about 95% or more, or about 99% or more, of the microorganisms (e.g., bacteria) on the surface and/or reduces the amount of microorganisms that form or grow on the surface by about 70% or more, about 80% or more, about 90% or more, about 95% or more, or about 99% or more, as compared to a similar surface without the composition disposed on the surface.

Although not intending to be bound by theory, the unique surface charge and surface chemistry of the mixed-valent copper materials and immobilized Quat materials of the local systemic particles may be responsible for maintaining good colloidal stability. The high surface area and gel-like structural morphology may be responsible for the strong adherence properties to a surface, such as a plant surface. The non-phytotoxicity may be attributed to the neutral pH of the LSP and limited availability of leachable and soluble ions. Additional details are described in the Examples.

A basic thrust of the embodiments is to develop a series of industrially viable LSP material formulations containing at least two multi-valent copper materials and an immobilized Quat material, in a particular chemical and geometric configuration.

In one embodiment, the LSP containing at least two multi-valent copper materials and Quat materials disclosed herein exhibit significant improvement in antimicrobial efficacy against copper-resistant bacteria (such as, X. perforans) over currently used film-forming standard copper materials (such as, but are not limited to, Kocide® 3000).

Advantageously, and in an enhanced embodiment, the LSP materials, as disclosed herein: exhibit the following characteristics: (1) when employed as a pesticide, the LSP materials are taken up by the stomata of the plants and serve as a copper reservoir for extended retention in plant tissue, thus enhancing bioavailability of copper material; (2) exhibit enhanced efficacy that is directly associated with the increase in copper bioavailability; and (3) have an integrated system containing multi-valent copper material and Quat that has a higher number of modes of action compared to a single valent copper material, thereby exhibiting high effectiveness against copper material resistant bacteria (e.g. X. perforans).

In yet another embodiment, the LSP material disclosed herein exhibits the following design criteria: (1) LSP material may be small enough to enter stomata; (2) the multi-valent copper material and the Quat material may be released from the LSP material to the surrounding tissues to exhibit locally-systemic pesticide antimicrobial activity; and (3) the LSP material exhibits non-phytotoxicity.

### 1.0 LSP General Structural Features

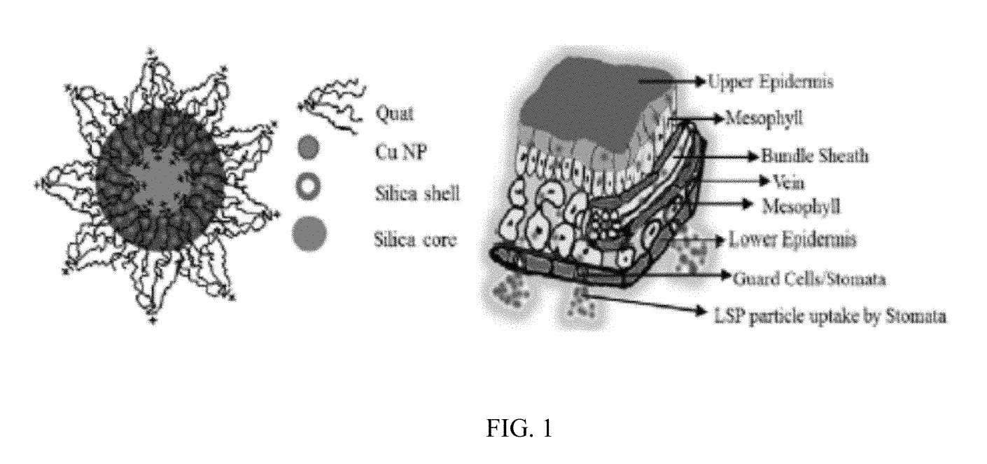

FIG. 1 shows a schematic diagram of a bi-modal multi-valent LSP design integrated with dual (i.e. metal (e.g. copper material) and non-metal (e.g. quaternary ammonium material) antimicrobial agents. As depicted, a silica core has been encapsulated with a silica shell that is loaded with multi-valence ultra-small size (about 5 nm, or more particularly about 5 to about 15 nm) copper (for instance, having zero, +1 and +2 oxidation states) nanoparticles (NPs). The outer silica surface has been coated with a bilayer of Quat material (also referred to herein as fixed-Quat). As understood, in one example, the immobilized Quat material layer may improve permeability of the LSP into the plant tissue. In addition, this immobilized Quat material layer may release the mobile antimicrobial Quaternary ions to further enhance antimicrobial efficacy. As one skilled in the art will understand, in one example, a particle size of an LSP particle may be tuned by changing a core size.

By way of example, and as depicted in FIG. 1, the core may be denominated as a silica core. Although, the core may include any of several materials (including, for instance, conductor materials and dielectric materials, in one embodiment, the core may include a metal oxide material, such as, but is not limited to, a silicon oxide material, a titanium oxide material, an aluminum oxide material, a zinc oxide, an aluminum-silicate (such as clay, zeolites; natural or engineered), a cerium oxide material, a zirconium oxide material, and the like. In one example, the core may have a diameter from about 50 nm to about 10000 nanometers, and more preferably from about 50 nm to about 1000 nanometers.

Further, as depicted in FIG. 1, the first shell layer may be denominated as a silica shell layer. By way of example, the silica shell layer (for instance, as described above in connection with the silica core) may also comprise any of several materials (for instance, including, but are not limited to, conductor materials and dielectric materials). Commonly, the first shell layer comprises an oxide material, such as, but is not limited to, a silicon oxide material, a titanium oxide material, an aluminum oxide material, a zirconium oxide material and the like. In a specific example, the first shell layer includes a silicon oxide material that has a thickness from about 2 nm to about 1000 nm, and more preferably from about 2 nm to about 100 nanometers.

Continuing with FIG. 1, copper material nanoparticles are located and formed into the first shell layer. Within the context of the embodiments the copper material nanoparticles may include at least two multivalent copper materials which are generally selected from the group including, but are not limited to, copper (0) materials, copper (I) materials and copper (II) materials, respectively. Typically, the copper nanoparticles include copper (I) materials and copper (II) materials that are located and formed within a silicon oxide matrix of the first shell layer, with loading capacity of copper from about 0.1 to about 10 weight percent within the first shell layer, and more preferably from about 0.1 to about 5 weight percent.

Continuing further with FIG. 1, a second shell layer may also be denominated as a Quat material layer, and more particularly, a bi-layer Quat material layer, where the bi-layer Quat material layer includes a first Quat material layer with quaternary nitrogen functionality that is embedded within the first shell layer to define the second shell layer, and a second Quat material layer of the bi-layer Quat material layer having quaternary nitrogen functionality either: (1) at an exposed surface of the second shell layer; or (2) extending from an exposed surface of the second shell layer. The Quat material is generally a quaternary ammonium material selected from the group including but not limited to C1 to C18 straight, branched, saturated and unsaturated quaternary ammonium materials. Typically, the second shell layer is located and formed upon the first shell layer to a thickness from about 1 nm to about 10 nanometers and more preferably from about 1 nm to about 5 nanometers.

In summary with respect to the above description, an LSP design in accordance with the embodiments commonly comprises or consists of a silica (or other metal oxide material) core, a composite silica (or other metal oxide material) first shell (the inner shell) and a quaternary ammonium (Quat) bilayer second shell (the outer shell). The inner shell embeds Cu in more than one oxidation states (0, +1, +2) as well as a positive quaternary nitrogen part of the Quat (via electrostatic interaction with silica negative charge, —Si—O⁻). The outer shell has a bilayer structure where the silica bound Quat layer interacts with another layer of Quat molecules through hydrophobic-hydrophobic interaction. The LSP in accordance with the embodiments is water-dispersible as the outermost Quat layer is hydrophilic due to the presence of positive charge Quat nitrogen head group. Within the context of the Examples that follow, concentrations of reactant materials are selected to provide the LSP structure as described above, in accordance with the embodiments.

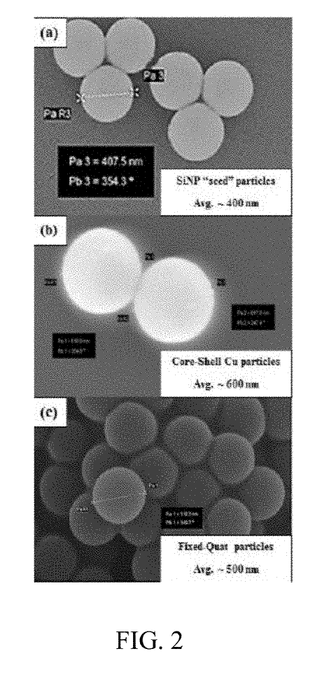

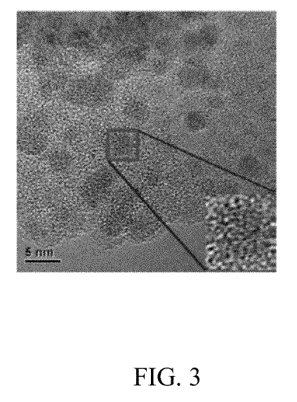

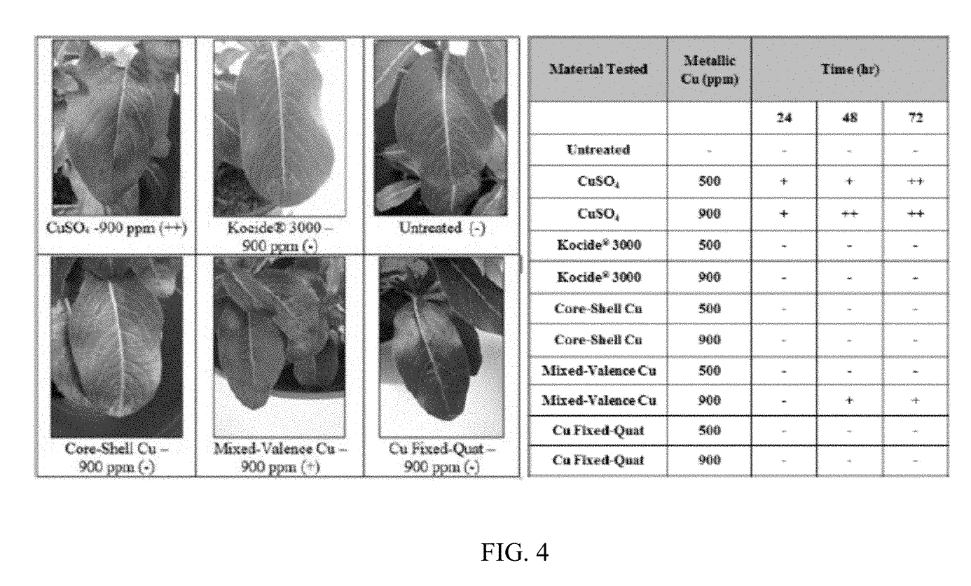

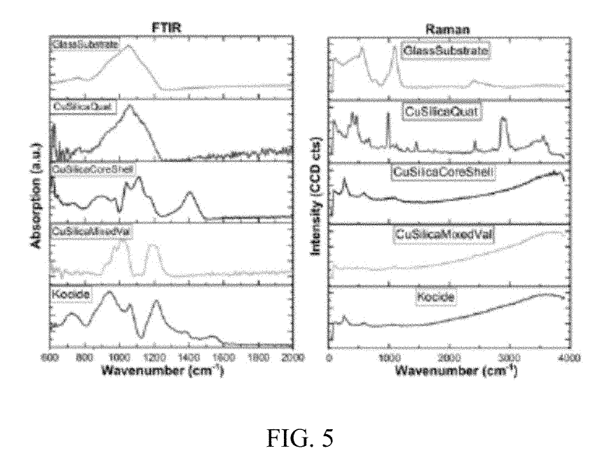

In one embodiment, results on LSP controls (that include, for instance, core-shell copper-loaded silica particle, multi-valent copper-loaded silica gel, immobilized Quat particles and copper-loaded immobilized Quat gel, respectively) demonstrate the following: (1) a copper-loaded silica shell has been fabricated over a silica “seed” particle, and (2) silica with multi-valent copper material exhibits improved antimicrobial efficacy relative to silica loaded with copper (II) material state alone, as depicted in FIGS. 2 and 3, respectively. By way of example, FIG. 2a shows a field emission scanning electron microscopy (FE-SEM) image of silica “seed” particles with an average particle size of 400 nm. As depicted, the average particle size increases to 600 nm (FIG. 2b) when the copper material loaded silica shell has been fabricated encapsulating the core. The embodiments also illustrate that Quat materials has been successfully immobilized over the 500 nm size silica “seed” particles (FIG. 2c), and that copper material with multi-valent states (Cu (0), Cu (I) and Cu (II)) has been created within silica matrix, respectively. Further, in another example, FIG. 3 shows a high-resolution transmission electron microscopy (HR-TEM) image of copper material loaded silica matrix. As depicted, ultra-small size (<10 nm) crystalline copper oxide material particles are seen embedded within the silica gel matrix. It is found that copper material is distributed throughout the silica matrix. This suggests that the silica matrix has been loaded with copper ions (chelated with negatively charged silica) as well as copper crystallites (data not shown). Within these embodiments, all the LSP controls were non-phytotoxic up to 500 ppm of metallic copper equivalent when evaluated using a model plant (e.g. ornamental Vinca sp.), which is highly susceptible to copper material and Quat material toxicity, as depicted in FIG. 4.

### 2.1 Examples of LSP Synthesis

Synthesis of the LSP particles has been achieved using the following steps. (i) Silica “seed” particles of three different sizes (50-100 nm, 100-300 nm and 400-600 nm) have been synthesized using Stöber sol-gel method with some modifications; and (ii) Cu-loaded silica shell has been grown as further described below to create multi-valent copper material, respectively. Note that, LSP overall size has been controlled by using the different sizes of “seed” particles.

### Example 1: Synthesis Protocol of 45 nm Size LSP Silica Core

Stöber colloidal silica synthesis technique was used with some modifications as follows: About 0.7 mL Ammonium Hydroxide (28-30 wt % ammonia in water), about 0.8 mL DI water and about 18 mL of Ethanol (absolute; 200 proof) were combined in a 50 mL conical flask and magnetically stirred (about 400 rotation per minute, rpm) for about 5 minutes. Next, about 0.8 mL of Tetraethylorthosilicate (TEOS, as received from the manufacturer) was added to the conical flask and continued stirring for about 2 hrs at about 400 rpm. Silica seed particles were isolated and purified from the reaction mixture using dialysis technique. In a typical procedure, about 10 mL of the reaction mixture was poured in a 3.5 kDa cellulose membrane (Spectrum Lab) and dialyzed against DI water (3.0 Liter) for about 72 hours (in every 8 hours DI water with impurities was replaced with fresh DI water). The silica seed particles were then stored as is for the synthesis of LSP.

### Example 2: Synthesis Protocol of 190 nm Size LSP Silica Core

Stöber colloidal silica synthesis technique was used with some modifications as follows: About 0.5 mL Ammonium Hydroxide (28-30 wt % ammonia in water), about 5 mL DI water and about 11 mL of Ethanol (absolute; 200 proof) were combined in a 50 mL conical flask and magnetically stirred (about 400 rotation per minute, rpm) for about 5 minutes. Next, about 0.5 mL of Tetraethylorthosilicate (TEOS, as received from the manufacturer) was added to the conical flask and continued stirring for about 2 hrs at about 400 rpm. Silica seed particles were isolated and purified from the reaction mixture using dialysis. In a typical procedure, about 10 mL of the reaction mixture was poured in a 3.5 kDa cellulose membrane (Spectrum Lab) and dialyzed against DI water (3.0 Liter) for about 72 hours (in every 8 hours DI water with impurities was replaced with fresh DI water). The silica seed particles were then stored as is for the synthesis of LSP.

### Example 3: Synthesis Protocol of 530 nm Size LSP Silica Core

Stöber colloidal silica synthesis technique was used with some modifications as follows: About 2 mL Ammonium Hydroxide (28-30 wt % ammonia in water), about 5 mL DI water and about 11 mL of Ethanol (absolute; 200 proof) were combined in a 50 mL conical flask and magnetically stirred (400 rotation per minute, rpm) for 5 minutes. Next, about 2 mL of Tetraethylorthosilicate (TEOS, as received from the manufacturer) was added to the conical flask and continued stirring for about 2 hrs at about 400 rpm. Silica seed particles were isolated and purified from the reaction mixture using dialysis. In a typical procedure, about 10 mL of the reaction mixture was poured in a 3.5 kDa cellulose membrane (Spectrum Lab) and dialyzed against DI water (3.0 Liter) for about 72 hours (in every 8 hours DI water with impurities was replaced with fresh DI water). The silica seed particles were then stored as is for the synthesis of LSP.

### Example 4: Synthesis Protocol of 60 nm Size LSP with a Core-Shell Structure

About 10 mL of dialyzed silica seed particles was transferred into a 50 mL conical flask. Under magnetic stirring conditions (about 400 rpm), about 50 microliters (μL) of 1% (V/V) hydrochloric acid was then added to the flask. Next, about 24 mg of Copper Sulfate Pentahydrate was added. After about 5 minutes, about 400 μL of TEOS was added dropwise (1 mL per minute). Next, about 150 μL of Didecyl Dimethyl Ammonium Chloride (DDAC, a Quaternary Ammonium Compound) was added to the reaction mixture and stirring was continued for about 1 hr. No further purification was done on this product formulation. DDAC has been electrostatically stabilized onto the colloidal silica particle surface. A dynamic equilibrium exists in solution between the unbound DDAC and the DDAC bound to silica particle surface. This has been done intentionally to control release of antimicrobial Quat and copper actives from LSP from the treated plant surface.

### Example 5: Synthesis Protocol of 255 nm Size LSP with a Core-Shell Structure

About 10 mL of dialyzed silica seed particles was transferred into a 50 mL conical flask. Under magnetic stirring conditions (about 400 rpm), about 30 microliters (μL) of 1% (V/V) hydrochloric acid was then added to the flask. Next, about 15 mg of Copper Sulfate Pentahydrate was added. After about 5 minutes, about 250 μL of TEOS was added dropwise (1 mL per minute). Next, about 90 μL of Didecyl Dimethyl Ammonium Chloride (DDAC, a Quaternary Ammonium Compound) was added to the reaction mixture and stirring was continued for about 1 hr. No further purification was done on this product formulation. DDAC has been electrostatically stabilized onto the colloidal silica particle surface. A dynamic equilibrium exists in solution between the unbound DDAC and the DDAC bound to silica particle surface. This has been done intentionally to control release of antimicrobial Quat and copper actives from LSP from the treated plant surface.

### Example 6: Synthesis Protocol of 615 nm Size LSP with a Core-Shell Structure

About 10 mL of dialyzed silica seed particles was transferred into a 50 mL conical flask. Under magnetic stirring conditions (about 400 rpm), about 115 microliters (μL) of 1% (V/V) hydrochloric acid was then added to the flask. Next, about 60 mg of Copper Sulfate Pentahydrate was added. After about 5 minutes, about 1 mL of TEOS was added dropwise (about 1 mL per minute). Next, about 220 μL of Didecyl Dimethyl Ammonium Chloride (DDAC, a Quaternary Ammonium Compound) was added to the reaction mixture and stirring was continued for about 1 hr. No further purification was done on this product formulation. DDAC has been electrostatically stabilized onto the colloidal silica particle surface. A dynamic equilibrium exists in solution between the unbound DDAC and the DDAC bound to silica particle surface. This has been done intentionally to control release of antimicrobial Quat and copper actives from LSP from the treated plant surface.

### Example 7: LSP Characterization

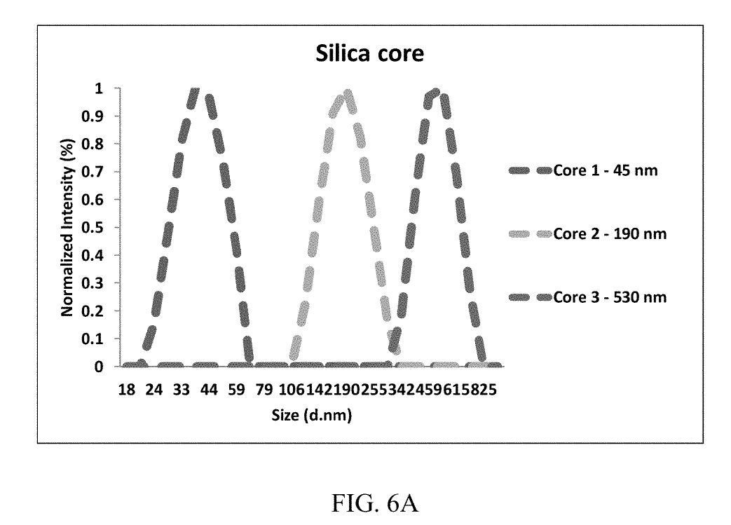

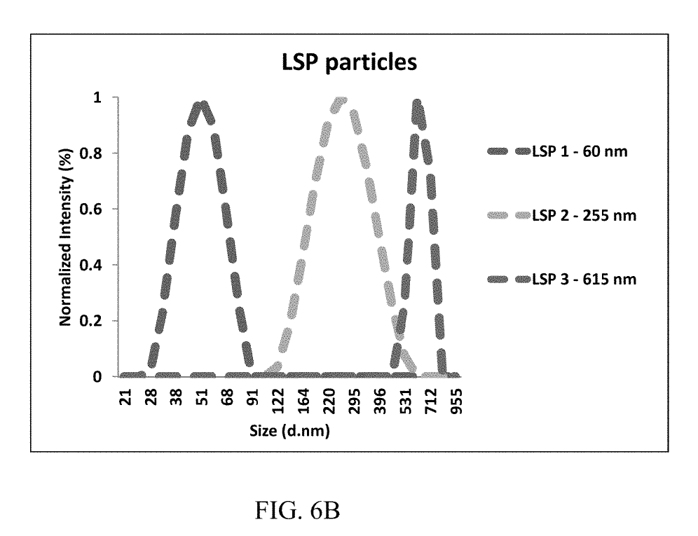

LSP particle size, size distribution and morphology have been characterized using HR-TEM, FE-SEM, although not depicted in the figures for the examples disclosed herein. Dynamic Light Scattering (DLS) technique has been used to characterize hydrodynamic diameter (size) and size distribution in solution state (e.g. water), as depicted in FIGS. 6A and 6B. Colloidal stability and opacity of the LSP formulation has been characterized using UV-Vis transmission measurements, although not depicted in the figures for the examples disclosed herein. Copper material oxidation states in multi-valent LSP component was characterized using x-ray photoelectron spectroscopy (XPS, a surface analysis technique) revealing Cu (0), (+1) and (+2) oxidation states. Chemical characterization of Quat attachment to LSP particle surface has done using FT-IR and Raman spectroscopy techniques, although not depicted in the figures for the examples disclosed herein. Note that, the FT-IR spectra indicated, an appearance of peaks in the range 3050-3150 cm⁻¹ characteristic of —C—H stretching confirming the presence of Quat material. Further, the FT-IR spectra also indicated the appearance of a 1080-1090 cm⁻¹ band which is characteristic of Si—O vibration stretching frequency and thereby indicating a Si—O—Si structure. FT-IR peak around 960 cm⁻¹ which is characteristic of Si—O vibration frequency in —Si—OH group was also observed. Atomic absorption spectroscopy (AAS) was also used for the estimation of copper material loading amount as well as residual analysis.

### Example 8: LSP Phytotoxicity Evaluation

To evaluate plant tissue damage (phytotoxicity) potential of the LSP materials, the following procedure has followed, in growth chamber conditions (Panasonic MLR-352H; temperature 90° F. and humidity 60-70%). Tomato plants have been chosen for this study. Plants were sprayed with LSP components at 7:00 am to avoid high heat exposure during the spray application. Plants were monitored for potential tissue damage for one week, although not depicted in the figures for the examples disclosed herein.

### Example 9: LSP In-Vitro Evaluation

### Bacterial Strains and Storage

Although not depicted in the figures, the antimicrobial properties of LSP materials and components were studied using standard microbiological technique to determine the Minimum Inhibitory Concentration (MIC). Samples were tested against Gram-negative Xanthomonas alfalfae subsp. citrumelonis strain F1 (ATCC 49120, a citrus canker surrogate), Gram-negative Pseudomonas syringae pv. syringae (ATCC 19310, causative agent of bacterial speck in Lilac, almond, apricots, peaches and wild beans among others) and Gram positive Clavibacter michiganensis subsp. michiganensis (ATCC 10202, causative agent of bacterial wilt and canker in Tomato sp). X. alfalfae and P. syringae were maintained with nutrient agar and broth while C. michiganensis was grown with brain heart infusion (BHI) media. All bacteria were grown at 26° C. in a shaking incubator (150 rpm).

Minimum Inhibitory Concentration (MIC) Assay

MIC was determined using two different methods:

a. Broth microdilution: Protocols as delineated by the Clinical and Laboratory Standards Institute (CLSI) were followed for conducting MIC studies to be in compliance with American Society of Microbiology guidelines. Serially diluted concentrations of candidate antimicrobial agents were added to Mueller-Hinton broth that was inoculated with 5×105 CFU/mL (0.5 McFarland standards) of specific bacteria. Under growth conditions, the lowest dilution of the test agent that exhibits complete inhibition of bacterial growth when examined under naked eye will be considered the MIC value. Since broth microdilution is based only on light absorbance, low concentration of bacteria can fall below the detection limit of the traditional optical density measurement. Therefore we complemented the study using alamar blue assays.

b. Alamar blue: Assays were conducted on the same plate as the broth microdilution assay to validate the results by following the same procedure as described in the previous paragraph (turbidity assay). The microlitre plates will be sealed with parafilm and incubated on a 150 rpm shaker for 24 hours at 28° C. The turbidity and color change of alamar blue dye was noted after 24 hours of incubation to determine the MIC value. Results have been summarized in Table 1 as follows:

| | E. coli | | X. alfalfae | |
|---|---|---|---|---|
| Material | (μg active/mL) | | (μg active/mL) | |
| LSP 1 - 60 nm | 0.3 (Quat) | 0.06 (Cu) | 0.6 (Quat) | 0.12 (Cu) |
| LSP 2 - 255 nm | 0.2 (Quat) | 0.04 (Cu) | 0.4 (Quat) | 0.08 (Cu) |
| LSP 3 - 615 nm | 0.45 (Quat) | 0.15 (Cu) | 0.9 (Quat) | 0.3 (Cu) |

| | | |
|---|---|---|
| Cu—SiNP 60 nm | 120 | 64 |
| Cu—SiNP 255 nm | 75 | 40 |
| Cu—SiNP 615 nm | 150 | 80 |
| Kocide ® 3000 | 250-500 | 250-500 |
| CuSO₄ | 250-500 | 125-250 |
| Quat | 2-4 | 2-4 |

Table 1 shows the enhanced antimicrobial efficacy of the LSP material compositions relative to those of the controls (e.g. Cu—SiNP, Kocide 3000, CuSO₄ and Quat, respectively)

Embodiments of the present disclosure may be applied on the time frames consistent with the effectiveness of the composition, and these time frames can include from the first day of application to about a week, about a month, about two months, about three months, about four months, about five months, about six months, about seven month, or about eight months.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to measurement techniques and the numerical value. In addition, the phrase “about ‘x’ to ‘y’” includes “about ‘x’ to about ‘y,’”

Many variations and modifications may be made to the above-described embodiments. All such modifications and variations are intended to be included herein within the scope of this disclosure and protected by the following claims.

What is claimed is:

1. A composition comprising at least one nanoparticle, the at least one nanoparticle comprising:
a first shell layer, the first shell layer comprising:
a leachant permeable base material; and
at least two different valence states of a metal material distributed and doped with respect to the leachant permeable base material, to provide a first multi-valent metal material doped shell layer; and
a second shell layer encapsulating the first multi-valent metal material doped shell layer and comprising an immobilized Quat material.

2. The composition of claim 1 wherein the first shell is formed upon a core that comprises a silicon oxide material.

3. The composition of claim 1 wherein the first shell is formed upon a core that comprises a metal oxide material selected from the group consisting of titanium oxide materials, aluminum oxide materials and zirconium oxide materials.

4. The composition of claim 1 wherein the at least two different valent states of the metal are selected from the groups consisting of:
Cu(0), Cu(I) and Cu(II); Zn(0) and Zn(II); Mg (0) and Mg (II); Ca (0) and Ca (II) and Ga (0) and Ga (III).

5. The composition of claim 2 wherein:
the core has a diameter from about 20 nm to about 10000 nanometers;
the first shell layer has a thickness from about 2 nm to about 1000 nanometers;
the first shell layer has a multi-valent metal material content from about 0.1 weight to about 10 weight percent within the first shell layer; and
the second shell layer has a thickness from about 1 to about 10 nanometers.

6. The composition of claim 1 wherein the immobilized Quat material comprises a bilayer Quat material that has a quaternary nitrogen functionality both:
embedded within the first shell layer; and
located at an outer surface of the second shell layer.

7. A treatment method comprising:
treating a plant with a composition, the composition comprising at least one nanoparticle, the at least one nanoparticle comprising:
a first shell comprising:
a leachant permeable base material; and
at least two different valence states of a metal material distributed and doped with respect to the leachant permeable base material, to provide a first multi-valent metal material doped shell layer; and
a second shell encapsulating the first multi-valent metal material doped shell layer and comprising an immobilized Quat material.

8. The method of claim 7 wherein the treating includes a foliar treating.

9. The method of claim 7 wherein the treating includes a root treating.

10. The method of claim 7 wherein the at least two different valent states of the metal are selected from the groups consisting of:
Cu(0), Cu(I) and Cu(II); Zn(0) and Zn(II); Mg (0) and Mg (II); Ca (0) and Ca (II); and Ga (0) and Ga (III).

11. The method of claim 7 wherein:
the first shell layer is formed upon a core that has a diameter from about 50 nm to about 10000 nanometers;
the first shell layer has a thickness from about 2 nm to about 1000 nanometers;
the first shell layer has a multi-valent metal material content from about 0.1 to about 10 weight percent within the first shell layer; and
the second shell layer has a thickness from about 1 nm to about 10 nanometers.

12. The method of claim 7 wherein the immobilized Quat material comprises a bilayer Quat material that has a quaternary nitrogen functionality both:
embedded within the first shell layer; and
located at an outer surface of the second shell layer.

13. A method for preparing a composition comprising:
forming a first shell layer that comprises a leachant permeable base material that includes at least two different valence states of a metal material distributed with respect to the leachant permeable base material to provide a first multi-valent metal material doped shell layer; and
forming upon the first multi-valent metal material doped shell layer a second shell layer encapsulating the first multi-valent metal material doped shell layer and comprising an immobilized Quat material.

14. The method of claim 13 wherein:
the first shell layer has a thickness from about 2 nm to about 1000 nanometers;
the second shell layer has a thickness from about 1 nm to about 10 nanometers,

15. The method of claim 13 wherein the first shell layer is formed with respect to a hollow core.

16. The method of claim 13 wherein the first shell layer is formed with respect to a solid core.

17. The method of claim 13 wherein the Quat material comprises a bilayer Quat material.

18. The method of claim 17 wherein the bilayer Quat material comprises:
a first quaternary nitrogen material located upon and embedded within an interface with the first shell layer; and
a second quaternary nitrogen material layer located at the exposed surface of the second shell layer.

19. The method of claim 18 wherein the bilayer Quat material is formed through:
electrostatic coulombic interactions between a negatively surface charged first material layer and a positively charged first Quat material layer; and
hydrophobic-hydrophobic interactions between the first Quat material layer and a second Quat material layer located and formed inverted upon the first Quat material layer.
